(19) United States
(12) Patent Application Publication
(10) Pub. No.: US 2006/0061663 A1
(43) Pub. Date: Mar. 23, 2006

(54) Digital camera with touch screen display panel usable as remote controller and method of operating the digital camera

(75) Inventor: Sang-woo Park, Seongnam-si (KR)

Correspondence Address: GARDNER CARTON & DOUGLAS LLP;ATTN: PATENT DOCKET DEPT., 191 N. WACKER DRIVE, SUITE 3700, CHICAGO, IL, 60606, US

(73) Assignee: Samsung Techwin Co., Ltd., Changwon-city (KR)

(21) Appl. No.: 11/064,644

(22) Filed: Feb. 24, 2005

(30) Foreign Application Priority Data
Sep. 20, 2004 (KR) 10-2004-0075076

(51) Int. Cl. H04N 5/232

(52) U.S. Cl. 348/211.2

(57) ABSTRACT

A digital camera with a detachable display panel that is usable as a remote controller and a method of operating the digital camera are provided. The digital camera includes (1) a camera body to photograph a subject, generate and process a photographed image of the subject; (2) a display panel that is detachable from the camera body and capable of remotely operating the camera body and displaying the photographed image; and (3) a coupling means to combine or separate the camera body and the display panel, wherein the camera body and the display panel communicate wirelessly to each other when separated.

This application claims the priority of Korean Patent Application No. 10-2004-0075076, filed on Sep. 20, 2004, in the Korean Intellectual Property Office, the disclosure of which is incorporated herein in its entirety by reference.

### BACKGROUND OF THE INVENTION

1. Field of the Invention

The present invention relates to a digital camera and a method of operating the digital camera. More particularly, it relates to a digital camera with a detachable touch screen display panel that is usable as a remote controller and to a method of operating the digital camera.

2. Description of the Related Art

FIG. 1 is a front view of a conventional digital camera.

Referring to FIG. 1, the digital camera includes a microphone MIC, a self-timer lamp 11, a flash 12, a shutter release button 13, a mode dial 14, a function select button 15, a photograph information display 16, a viewfinder 17a, a function block button 18, a flash-intensity sensor 19, a lens 20, and an external interface 21.

The self-timer lamp 11 operates during a time period from when the shutter release button 13 is pressed until a shutter starts operating. The mode dial 14 is used by a user to select various modes, such as, a still picture photography mode, a night view photography mode, a motion picture photography mode, a replay mode, a computer connection mode, and a system setup mode. The function select button 15 can also be used by the user to select one of the modes of the digital camera 1, such as, the still picture photography mode, the night view photography mode, the motion picture photography mode, and the replay mode. The photography information display 16 displays information of photographic functions. The function block button 18 is used by the user to select any of the functions displayed on the photography information display 16.

FIG. 2 is a rear view of the conventional digital camera of FIG. 1.

Referring to FIG. 2, the digital camera includes a speaker SP, a power button 31, a monitor button 32, an automatic focus lamp 33, a viewfinder 17b, a flash standby lamp 34, a display panel 35, an exposure correct/delete button 36, an enter/replay button 37, a menu/OK button 38, a wide angle zoom button 39w, a telephoto zoom button 39t, an up shift button 40up, a right shift button 40ri, a down shift button 40lo, and a left shift button 40le on the backside.

The monitor button 32 is used by the user to adjust operations of the display panel 35. For example, if the user presses the monitor button 32 a first time, a photographed image of a subject and corresponding photography information are displayed on the display panel 35. If the monitor button 32 is pressed a second time, only the photographed image is displayed on the display panel 35. And if the monitor button 32 is pressed a third time, the power supplied to the display panel 35 is cut off. The monitor button 32 is also used to select the image in parts for a resolution change.

The automatic focus lamp 33 operates right after an automatic focusing is complete.

The flash standby lamp 34 operates when a flash 12 of FIG. 1 is on standby.

The exposure correct/delete button 36 is used to adjust light intensity, or used as a delete button while the user establishes any modes. The exposure correct/delete button 36 is also used to consecutively select the image for a resolution change.

The enter/replay button 37 is used for receiving data entered by the user, or used to instruct to pause or play in the replay mode.

The menu/OK button 38 is used to display and select a menu of a mode selected by the mode dial 14.

The up, right, down, and/or left shift buttons 40up, 40ri, 40lo, and/or 40le are also used while the user establishes modes.

Recently, a digital camera with a detachable LCD panel usable as a remote controller has been developed. However, this disclosed digital camera comprises a camera body to capture images and a separate receiver to receive and display the captured images. These components are separated from each other and are restricted in function in that unidirectional communication is used to send captured images to the receiver. In addition, such a digital camera is bulky and difficult to operate.

### SUMMARY OF THE INVENTION

The present invention provides a digital camera with a touch screen display panel that is detachable from a camera body and usable as a remote controller. A method of operating the digital camera is also provided.

According to an embodiment of the present invention, there is provided a digital camera comprising: a camera body to photograph a subject and to generate and process a photographed image of the subject; a display panel that is detachable from the camera body and is used to remotely operate the camera body and display the photographed image; and a coupling means to combine or separate the camera body and the display panel, wherein the camera body and the display panel communicate to each other via wire or wirelessly when separated.

According to an embodiment of the present invention, the display panel is a touch screen that receives a user's command.

According to an embodiment of the present invention, the display panel comprises: a display to indicate whether a wireless communication is being normally performed between the camera body and the display panel; and a shutter release button to enter a command for the camera body to photograph the subject.

According to an embodiment of the present invention, a front view of the display panel comprises: a first display area to display an image of a subject photographed by the camera body; and a second display area to display menu buttons which a user touches in order to manipulate the photographed image displayed on the first display area or to input a command to operate the camera body.

According to an embodiment of the present invention, a backside of the display panel comprises: a plurality of terminals to transmit or receive power or data to or from the camera body when the display panel is attached to the camera body.

According to an embodiment of the present invention, the camera body comprises: a photography unit to photograph the subject and convert the result to an electrical photographed image; a image processor to process the photographed image according to a user's command; a data transmitting/receiving unit to transmit or receive data (including the image) to or from the display panel by a wire or wirelessly; and a micro-controller to perform functions such as checking whether the display panel is detached from the camera body, determining a data communication state with the display panel, controlling the camera body to transmit the photographed image to the display panel, and controlling the camera body to perform an operation according to a command received from the display panel.

According to an embodiment of the present invention, the display panel comprises: a data transmitting/receiving unit to communicate data with the camera body by a wire or wirelessly; a display to display a menu for adjusting the photographed image received from the camera body or for remotely instructing the camera body's operation; a sensor unit to detect a touch on the menu displayed on the display; and a micro-controller to perform functions such as checking whether the display panel is detached from the camera body and controlling the display panel to transmit a signal generated by the touch on the menu to the camera body if the display panel is detached.

According to an embodiment of the present invention, the digital camera further comprises a memory to store the image photographed by the camera body.

According to an embodiment of the present invention, the digital camera further comprises a power unit to supply power to the detached display panel.

According to an embodiment of the present invention, the micro-controller enables a display panel power unit if the display panel is detached from the camera body and disables the display panel power unit if the display panel is attached to the camera body.

According to another embodiment of the invention, there is provided a method of operating a digital camera comprising a camera body that photographs a subject and processes the photographed image of the subject, and a display panel that is detachable from the camera body and is capable of remotely instructing the camera body's operation and displaying the photographed image received from the camera body, the method comprising: determining whether the display panel is detached from the camera body; determining a communication state between the camera body and the display panel; and performing an operation according to a command received through the display panel, if the display panel is detached and the communication state is normal.

According to an embodiment of the present invention, the display panel is a touch screen that can receive a user's command.

According to an embodiment of the present invention, the method further comprises supplying power to the display panel with a display panel power unit if it is determined that the display panel is detached from the camera body.

According to an embodiment of the present invention, the method further comprises displaying the communication state on the display panel to indicate whether the communication state is normal or abnormal.

### BRIEF DESCRIPTION OF THE DRAWINGS

The above and other aspects and advantages of the present invention will become more apparent by describing in detail preferred embodiments thereof with reference to the attached drawings in which:

FIG. 1 is a front view of a conventional digital camera;

FIG. 2 is a rear view of a conventional digital camera;

FIG. 3 is a rear view of a digital camera with a touch screen display panel usable as a remote controller, according to an embodiment of the present invention;

FIG. 4 shows a digital camera with a touch screen display panel detached from the camera body, according to an embodiment of the present invention;

FIGS. 5A and 5B are front and rear views of the touch screen display panel of FIG. 4;

FIG. 6 is a block diagram illustrating a digital camera according to an embodiment of the present invention; and

FIG. 7 is a flowchart illustrating a method of operating a digital camera with a touch screen display panel that is usable as a remote controller.

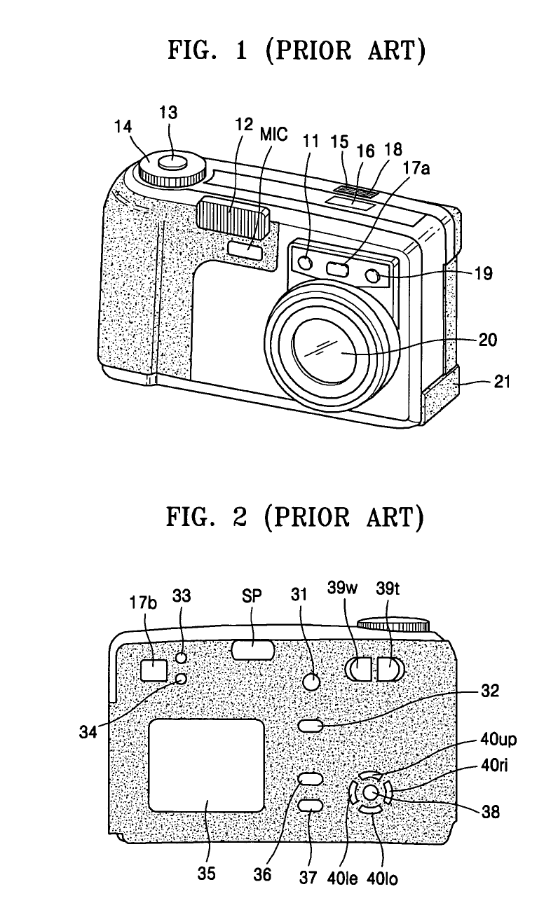

### DETAILED DESCRIPTION OF THE INVENTION

Exemplary embodiments of the present invention will now be described in detail with reference to the attached drawings.

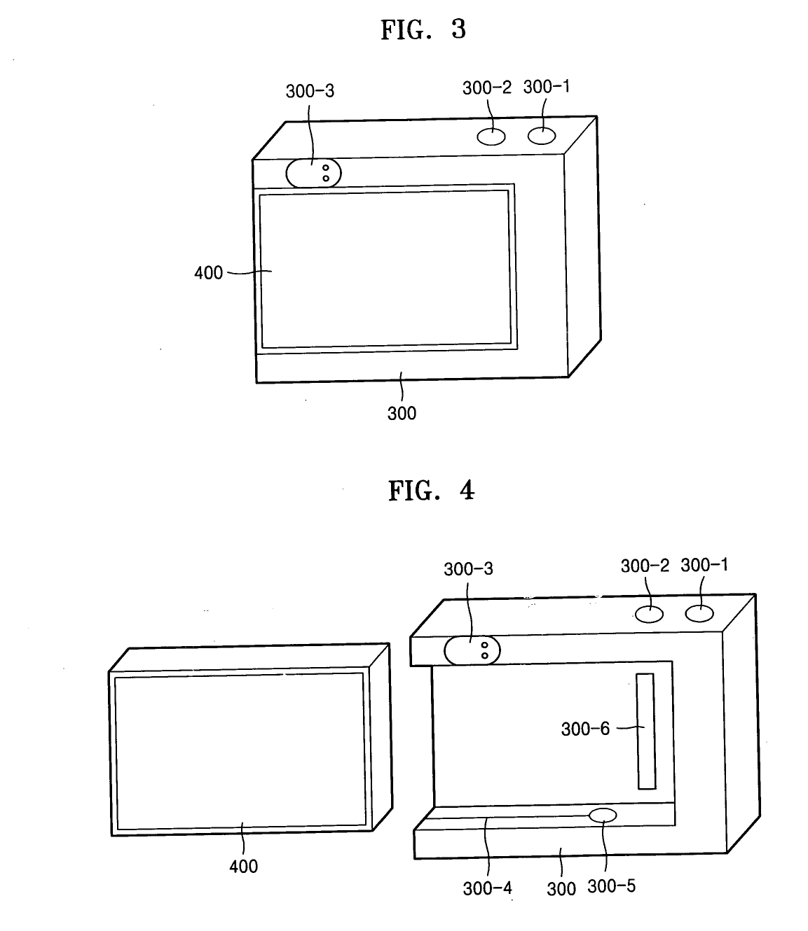

FIG. 3 is a rear view of a digital camera with a touch screen display panel that is usable as a remote controller, according to an embodiment of the present invention.

Referring to FIG. 3, the digital camera consists of a camera body 300 including a shutter release button 300-1, a power key 300-2, and a viewfinder 300-3, and a touch screen display panel 400 that is detachable from the camera body 300.

The camera body 300 does not include all of the buttons required by a user to operate the camera, since buttons are also displayed on the touch screen display panel 400.

Displaying the manipulation buttons on the touch screen display panel 400 possibly causes the display panel 400 to be larger in size than it would be if such buttons were not displayed, but the size of the camera body 300 may be reduced because it does not have to include manipulation buttons.

FIG. 4 shows a digital camera with the touch screen display panel 400 detached from the camera body 300, according to an embodiment of the present invention;

While in a detached state, the camera body 300 and the touch screen display panel 400 perform wireless data communication with each other.

The camera body 300 has a sliding groove 300-4 through which the touch screen display panel 400 is attached to or detached from the camera body 300, a lock 300-5 that is used for the touch screen display panel 400 to be fixed in the sliding groove 300-4, and a terminal 300-6 for transmitting/receiving power and data to/from the display panel when the touch screen display panel 400 is attached to the camera body 300.

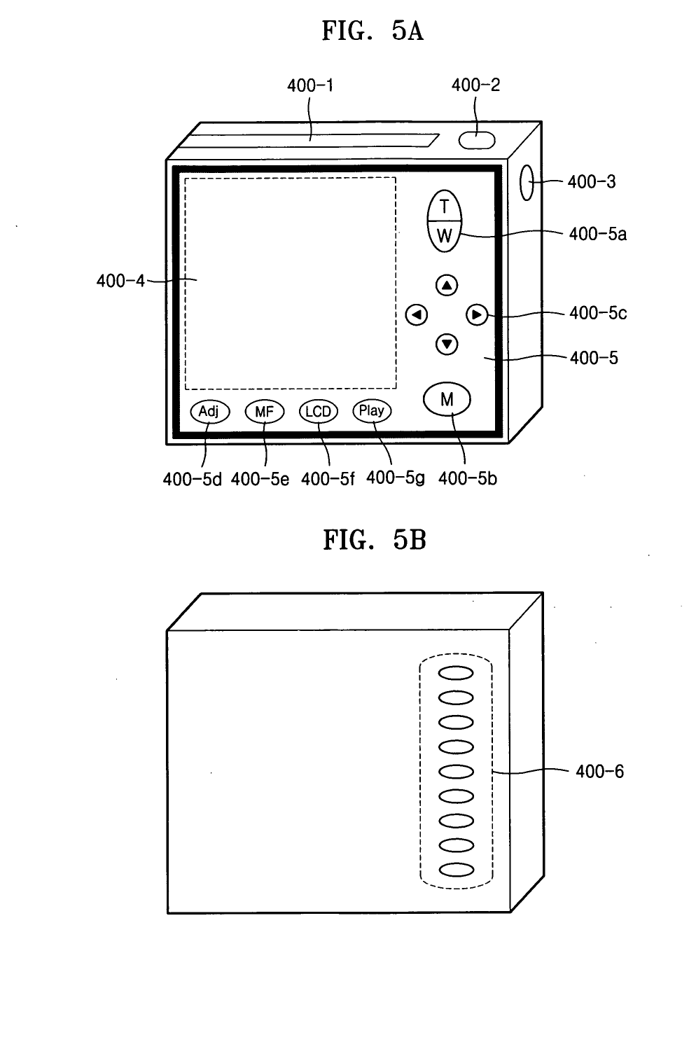

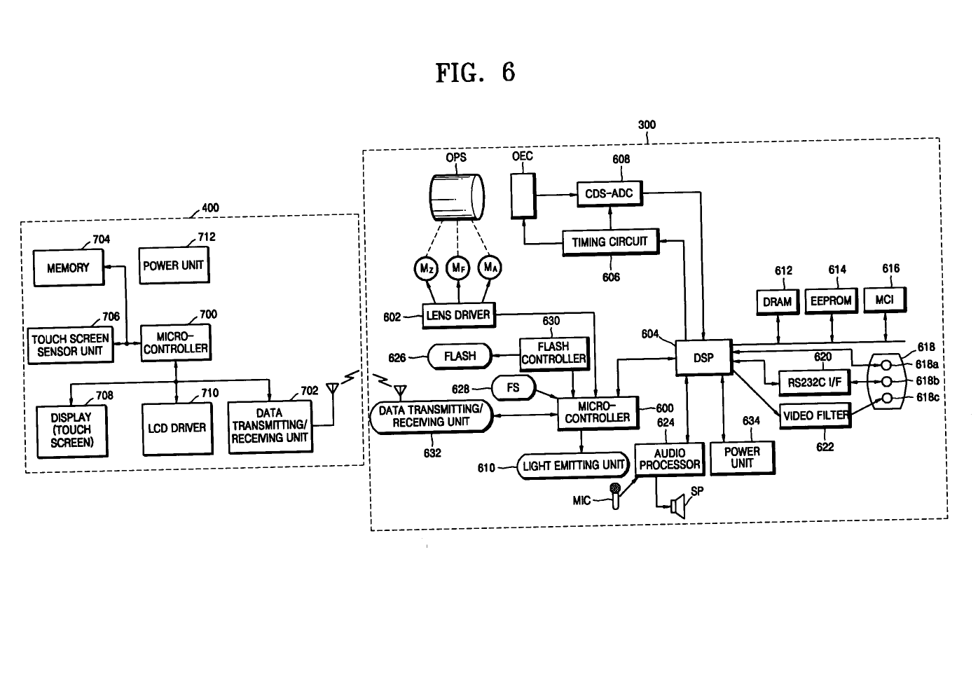

FIGS. 5A and 5B are front and rear views of the detached touch screen display panel 400 of FIG. 4, respectively.

As shown in FIG. 5A, the detached touch screen display panel 400 comprises a sliding groove 400-1 through which the display panel 400 can be attached to or detached from the camera body 300, a display 400-2 to display a communication state between the detached touch screen display panel 400 and the camera body 300, and a shutter release button 400-3 to remotely instruct the camera body 300 to photograph a subject.

The touch screen display panel 400 is divided into two display areas: a first display area 400-4, and a second display area 400-5. The first display area 400-4 displays the image photographed and processed by the camera body 300. The second display area 400-5 displays a menu which enables a user to adjust the image displayed on the first display area 400-4 or remotely instruct the camera body 300 to operate when menu buttons are touched by the user.

An enlarged version of the photographed image can be displayed by setting the menu to enable the display panel 400 to display the image on an enlarged display area comprised of the first display area 400-4 and the second display area 400-5. When an image is displayed on both the first display area 400-4 and the second display area 400-5, the menu does not appear on the second display area 400-5.

The menu displayed on the second display area 400-5 comprises a plurality of buttons: a zoom W/T button 400-5a, an M (menu) button 400-5b, a direction button 400-5c, an Adj button 400-5d, an MF button 400-5e, an LCD button 400-5f, and a Play button 400-5g.

The zoom W/T button is used as an optical zoom button or a digital zoom button. If a T button of the zoom W/T is pressed, the subject being photographed appears to come closer to the camera body 300, and if a W button is pressed, the subject appears further from the camera body 300.

If the M button 400-5b is touched once, a menu of an operational mode of the digital camera is displayed, and if it is touched one more time, the display returns to a previous display state.

The direction button 400-5c is used to move across the menu for operating the digital camera.

The Adj button 400-5d is used to select an exposure correction button, a white balance button, an ISO button, an RGB button, an A/S/M button, or an extended shutter time button for the photography mode. If the user touches the Adj button 400-5d and then touches the exposure correction button, the extent of the exposure appropriate for a corresponding photography situation can be manually adjusted. If the user touches the Adj button 400-5d and next touches the white balance button, white balance can be adjusted to obtain a natural tone of images. If the user touches the Adj button 400-5d and next the ISO (a unit of film sensitivity) button, sensitivity in photographing an image can be selected. If the user touches the Adj button 400-5d and next the RGB button, R, G, B values of the image to be photographed are adjusted. If the user touches the Adj button 400-5d and next the A/S/M button, a speed of the shutter or a value of an iris can be set up, as planned by the user. If the user touches the Adj button 400-5d and next the extended shutter time button, the speed of the shutter or the value of the iris in night view mode can be set up.

The MF button 400-5e is for setting a focusing method. Whenever the MF button 400-5e is touched, the focusing method sequentially changes between manual focusing, consecutive automatic focusing, and automatic focusing.

The LCD button 400-5f is a button for turning the display panel 400 on or off; if it is touched once, the display panel 400 is turned on, and then if it is touched one more time, the display panel 400 is turned off.

The play button 400-5g is a button for starting or stopping motion picture reproduction.

On the backside of the touch screen display panel, as shown in FIG. 5B, there is a terminal 400-6 for transmitting/receiving power and data to/from the camera body 300 when the touch screen display panel 400 is attached to the camera body 300.

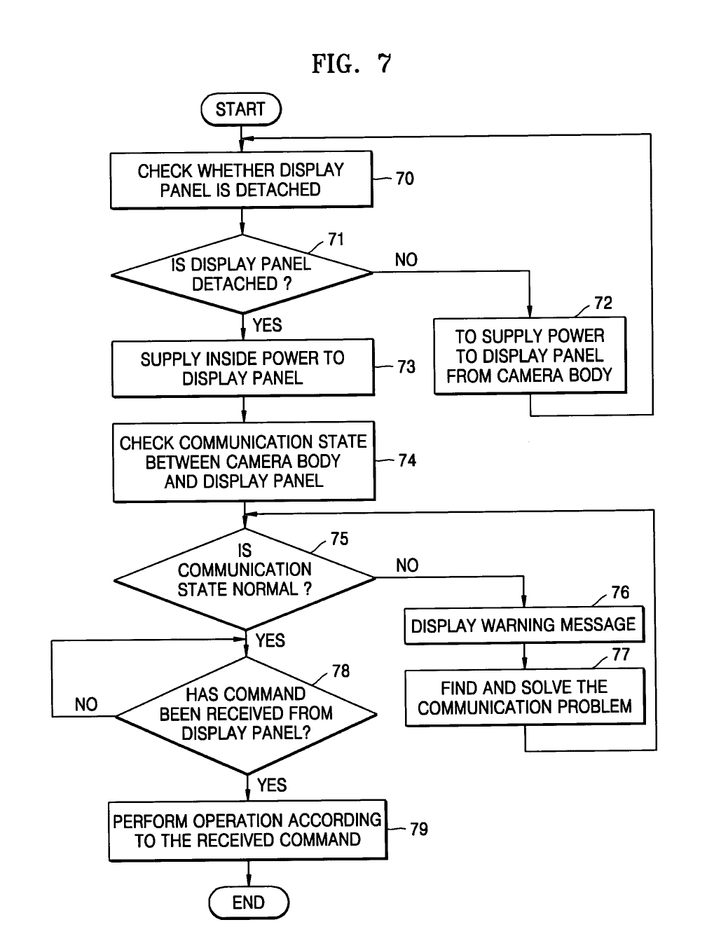

FIG. 6 is a block diagram illustrating the configuration of a digital camera according to an embodiment of the present invention, the digital camera comprising the camera body 300 and the touch screen display panel 400 that is detachable from the camera body 300.

The digital camera body 300 will now be described with reference to FIGS. 3-4 and 6.

An optical system (OPS) comprising lens and filter units (not shown) optically processes light reflected from a subject being photographed. The lens unit of the OPS includes a zoom lens (ZL), a focus lens (FL), and a correction lens (CL).

When a wide-angle zoom command or a telephoto zoom command is received from the display panel 400, wherein the command is generated according to a user's manipulation on the display panel 400, a corresponding command signal is input to a micro-controller 600. Accordingly, the micro-controller 600 controls the lens driver 602 to drive a zoom motor (M_{Z}) to move the ZL. Specifically, when the wide-angle zoom button W of the zoom W/T button 400-5a of the display panel 400 shown in FIG. 5A is pressed by the user, and a corresponding wide-angle zoom command is generated and transmitted to the micro-controller 600 of the camera body 300, the micro-controller 600 controls a focal length of the ZL to be shorter and the angle of view to be wider. If the telephoto zoom button T of the zoom W/T button 400-5a of the display panel 400 shown in FIG. 5A is pressed by the user and a corresponding telephoto zoom command is generated and transmitted to the micro-controller 600 of the camera body 300, the micro-controller 600 controls the focal length of the ZL to be longer and the angle of view to be narrower. Afterwards, the micro-controller 600 transmits the resulting image to the touch screen display panel 400. The micro-controller 600 transmits the resulting image to the touch screen display panel 400 wirelessly if the touch screen display panel 400 is detached from the camera body 300.

The micro-controller 600 obtains the angle of view θ with respect to a position of ZL from the design specification of OPS. Here, since the position of the focal lens is adjusted after the position of ZL is set, the angle of view θ is hardly affected by the position of FL. The correction lens CL corrects a refractive index and does not operate independently.

M_{A} is a motor to drive an aperture (not shown). The rotating angle of M_{A} depends on whether the digital camera is in a designated exposure mode. The designated exposure mode is a mode in which, if a certain range of a photography area selected by the user corresponds to a designated detection range displayed on the display panel 400, the intensity of the exposure of the digital camera is set up with respect to an average brightness of the designated detection range.

In the filter unit of the OPS, an optical low-pass filter OLPF eliminates optical noise with high frequency components. In addition, an infrared cut filter IRF cuts off infrared components of incident light.

An Optical-to-Electrical conversion unit (OEC) including a charge coupled device (CCD) or a complementary metal oxide semiconductor (CMOS) converts the light received from the OPS to an electrical analog signal. For this, a digital signal processor (DSP) 604 controls a timing circuit 606 to control operations of OEC and an analog-to-digital converter 608. The analog-to-digital converter 608, referred to as a correlation double sampler and analog-to-digital converter CDS-ADC, handles an analog signal received from OEC to eliminate high frequency noise therefrom, adjust an amplitude thereof, and then converts it to a digital signal. The digital signal processor 604 processes the digital signal received from the CDS-ADC 608 to generate a digital image signal divided into luminance and chroma signals.

A light emitting unit 610 driven by the micro-controller 600 includes a self-timer lamp, an automatic-focus lamp, and a flash-standby lamp.

A Dynamic Random-Access Memory (DRAM) 612 temporarily stores the digital image signal received from the digital signal processor 604.

An Electrically Erasable Programmable Read-Only Memory (EEPROM) 614 stores algorithms and data settings which are required for the operation of the digital signal processor 604.

A memory card interface (MCI) 616 accepts a detachable user memory card (not shown).

The digital image signal from the digital signal processor 604 is transmitted to the display panel 400 via the data transmitting/receiving unit 632 of the camera body 300. The digital image signal from the digital signal processor 604 may also be transmitted as serial communications through a universal serial bus USB connector 618a or through an RS232C interface 620 using a connector 618b. The digital image signal may also be output to the display panel 400 as a video signal via a video filter 622 and a video output 618c.

An audio processor 624 is capable of relaying an audio signal received from a microphone MIC to the digital signal processor 604 or to a speaker SP. The audio processor 624 is also used to output an audio signal received from the digital signal processor 604 to the speaker SP.

A flash 626 is controlled by both the micro-controller 600 and a flash controller 630 in response to a signal generated by a flash intensity sensor FS 628.

When the display panel 400 is detached from the camera body 300, a data transmitting/receiving unit 632 wirelessly receives a command to perform an operation from the detached display panel 400, performs a corresponding operation according to the command, and wirelessly transmits the result back to the display panel 400. If the display panel 400 is attached to the camera body 300, the data transmitting/receiving unit 632 communicates with the display panel 400 by a wire, via the terminal 300-6 as shown in FIG. 4.

When power for operating the camera body 300 is supplied from a power unit 634, the camera body 300 starts operating, executes operations according to commands received from the detached display panel 400, and returns the result to the display panel 400.

The display panel 400, which is now assumed to be detached from the camera body 300, will now be described. The display panel 400 is also used as a remote controller to remotely control operations of the camera body 300.

A data transmitting/receiving unit 702 receives or transmits signals from the camera body 300, under the control of a micro-controller 700 in the display panel 400.

A memory 704 stores menu data for the operation of the camera body 300 and/or the photographed image signals transmitted by the camera body 300 and through the display panel's data transmitting/receiving unit 702.

A touch screen sensor unit 706 detects a touch on the menu displayed on the second display area 400-5 (see FIG. 5A) of the display 708. The detection result is output to the micro-controller 700, which generates a corresponding command to transmit to the camera body 300 via the data transmitting/receiving unit 702.

An LCD driver 710 drives the LCD display unit 708 by a control of the micro-controller 700.

A power unit 712 in the display panel 400 operates to supply power to the display panel 400 only when the display panel 400 is detached from the camera body 300. The micro-controller 700 detects whether the display panel 400 is detached, and if so, enables the operation of the power unit 712. If the display panel 400 is attached to the camera body 300, the micro-controller 700 disables the operation of the power unit 712.

When the user enters a command by touching one of menu buttons 400-5a to 400-5g (see FIG. 5A) to adjust the photographed image displayed on the first display area 400-4 (see FIG. 5A) of the display 708, the command is wirelessly transmitted to the camera body 300 through the data transmitting/receiving unit 702. Then, the camera body 300 performs a corresponding operation under the control of the micro-controller 600 and transmits the result of the operation back to the display panel 400 through the transmitting/receiving unit 632 of the camera body 300. The user can also manipulate any menu displayed on the second display area 400-5 to instruct the camera body 300 to photograph a subject as desired.

FIG. 7 is a flowchart illustrating a method of operating a digital camera with a touch screen display panel that is usable as a remote controller. The method of FIG. 7 will now be described with reference to FIGS. 4, 5B, 6 and 7.

First, in operation 70, the micro-controller 600 checks whether the display panel 400 is attached to or detached from the camera body 300. To do this, the micro-controller 600 checks whether the terminal 300-6 of the camera body shown in FIG. 4 and the terminal 400-6 of the display panel 400 shown in FIG. 5B are coupled with each other. If they are coupled to each other, the micro-controller 600 determines that the display panel 400 is attached to the camera body 300; otherwise, it determines that the display panel 400 is detached from the camera body 300.

When the micro-controller 600 determines that the display panel 400 is attached to the camera body 300 in operation 71, the power unit 634 of the camera body 300 supplies power to the display panel 400 in operation 72.

When the micro-controller 600 determines that the display panel 400 is detached from the camera body 300 in operation 71, the power unit 712 of the display panel 400 supplies power to the display panel 400 in operation 73.

Next, the micro-controller 600 checks a data communication state between the camera body 300 and the display panel 400 in operation 74. The micro-controller 600 may perform test communication between the data transmitting/receiving unit 632 of the camera body 300 and the corresponding data transmitting/receiving unit 702 of the display panel 400 to determine whether data communication is available therebetween.

If, in operation 75, the micro-controller 600 determines that the data communication between the camera body 300 and the display panel 400 was abnormally performed during operation 74, the micro-controller 600 causes the display of a warning notice in operation 76. The micro-controller 700 of the display panel 400 also checks the data communication state between the camera body 300 and the display panel 400. If the micro-controller 700 of the display panel 400 determines that the data communication is abnormally performed, it also causes a warning notice to be displayed on the first display area 400-4 and/or activates a red light on the communication state display 400-2.

In the case where the data communication is abnormally performed between the camera body 300 and the display panel 400, each micro-controller 600 or 700 may take certain measures to find a cause and recover normal data communication between them in operation 77. The camera body 300 and the display panel 400 are on standby until the data communication between them is normally performed.

If the micro-controller 600 determines that the data communication between the camera body 300 and the display panel 400 is normally performed in operation 75, it turns on a green light on the communication state display 400-2.

Next, in operation 78, the micro-controller 600 checks whether a command has been received from the display panel 400, and if so, the micro-controller 600, in operation 79, then performs an operation corresponding to the received command.

In addition, when a user touches one of menu buttons 400-5a to 400-5g displayed on the second display area 400-5 of FIG. 5B to enter a command to operate on the photographed image displayed on the first display area 400-4 of the touch screen display panel 400, the command is wirelessly transmitted to the camera body 300 via a data transmitting/receiving unit 702 on the display panel 400. Then, the camera body 300 receives the command through its data transmitting/receiving unit 632, and the micro-controller 600 performs a corresponding operation according to the command. The operation result is wirelessly transmitted back to the display panel through the camera body's data transmitting/receiving unit 632. The user may also remotely photograph images as desired, by manipulating menu buttons displayed on the second display area 400-5 of the display panel 400.

According to the present invention, as described above, various conventional hardware operational buttons of a digital camera can be eliminated by using a touch screen display panel also used as a remote controller. With the display panel, not only images can be monitored, but also the digital camera can be controlled through bi-directional communication between the display panel and the camera body. Furthermore, since the display panel of a touch screen can be attached to or detached from the camera body by sliding the display panel into or out of the camera body and operational buttons are implemented on the touch screen display panel, the size of the entire digital camera can be smaller and more compact. With the display panel used as the remote controller and equipped with various functions to meet the user's demands, the user can efficiently manipulate the digital camera from a remote location.

While this invention has been particularly shown and described with reference to preferred embodiments thereof, it will be understood by those skilled in the art that various changes in form and details may be made therein without departing from the spirit and scope of the invention as defined by the appended claims.

What is claimed is:

1. A digital camera, the digital camera comprising:
a body portion for capturing and processing an image of a subject, the body portion comprising a lens unit that receives light from the subject to be photographed by the camera, an optical-to-electrical conversion unit that converts the received light into electrical signals, and a digital processor that receives the signals generated by the optical-to-electrical conversion unit and processes the signals to generate an image of the signal; and
a display panel, coupled to and detachable from the body portion, wherein the display panel performs steps comprising:
when the display panel is detached from the body portion, wirelessly communicating with the body portion;
receiving the image from the body portion;
displaying the received image on the display panel; and
in response to a user input at the display panel, transmitting a command to the body portion.

2. The digital camera of claim 1, wherein the display panel includes a touch screen capable of receiving a user's command.

3. The digital camera of claim 1, wherein the display panel comprises means for indicating whether a wireless communication link between the body portion and the display panel is operating normally.

4. The digital camera of claim 1, wherein the display panel comprises means for a user to enter a command for the body portion to photograph the subject.

5. The digital camera of claim 2, wherein the display panel comprises:
a first display area to display the image of the subject photographed by the body portion; and
a second display area to display menu buttons for operating the body portion and for manipulating the photographed image displayed on the first display area; and
a plurality of terminals to transmit or receive power or data between the display panel and the body portion when the display panel is attached to the body portion.

6. The digital camera of claim 5, wherein the display panel further comprises:
a sensor unit to detect a user's touch on the display panel;
a power unit for providing power to the display panel;
a digital processor for controlling operations of the display panel and the body portion in response to an input detected by the sensor unit; and
a memory.

7. The digital camera of claim 6, wherein the digital processor enables the power unit if the display panel and the body portion are detached from one another and disables the power unit if the display panel and the body portion are attached to one another.

8. The digital camera of claim 6, wherein the memory stores images which were captured by the body portion and transmitted to the display panel.

9. The digital camera of claim 1, wherein the body portion receives the display panel when the display panel is coupled to the body portion.

10. The digital camera of claim 9, wherein the body portion further comprises at least one groove for receiving a corresponding ridge on the display panel and a lock for fixing the position of the display panel relative to the body portion.

11. A display panel for a digital camera, the display panel comprising:
a display screen for displaying images captured by the photographing apparatus;
means for wirelessly exchanging data with the photographing apparatus from a location remote from the photographing apparatus;
a user input unit for receiving user instructions for the operation of the display panel and the photographing apparatus; and
a digital processor for directing the operation of the display panel and controlling the operation of the means for exchanging data with the photographing apparatus.

12. The display panel of claim 11, further comprising a plurality of terminals to transmit or receive power or data between the display panel and the camera body when the display panel is attached to the camera body.

13. The display panel of claim 11, wherein the display screen is a touch screen.

14. The display panel of claim 13, further comprising a sensor unit to detect a user's touch on the display screen.

15. The display panel of claim 14, wherein a first display area of the display screen displays an image of a subject photographed by a photographing apparatus and a second display area of the display screen displays a plurality of buttons capable of generating command signals when a user touches any of the plurality of buttons.

16. The display panel of claim 15, wherein the plurality of buttons comprises buttons selected from the group consisting of a shutter release button, a wide-angle zoom button, a telephoto zoom button, a menu button, a direction button, a focusing method button, a display screen control button, a playback control button, and a photographing settings adjustment button.

17. A method of operating a digital camera comprising a camera body that photographs a subject and processes the photographed image of the subject and a display panel that is coupled to and detachable from the camera body for remotely instructing the camera body's operation and displaying the images of subjects photographed by the camera body, the method comprising:
detecting whether the display panel is detached from the camera body;
determining whether the display panel and camera body are communicating with each other normally;
if the display panel and camera body are not communicating normally, displaying a warning message;
if the display panel and camera body are communicating normally, determining whether the camera body has received a command signal from the display panel; and
if the camera body has received a command signal from the display panel, performing an operation corresponding to the command signal.

18. The method of claim 17, further comprising:
if the display panel is detached from the camera body, supplying power to the display panel via a display panel power unit.

19. The method of claim 17, wherein the display panel includes a touch screen capable of receiving a user's command.

20. The method of claim 17, wherein the display panel and the camera body communicate wirelessly when the display panel is detached from the camera body.
